(19) United States
(12) Patent Application Publication
(10) Pub. No.: US 2012/0265526 A1
(43) Pub. Date: Oct. 18, 2012

(54) APPARATUS AND METHOD FOR VOICE ACTIVITY DETECTION

(75) Inventors: Suat Yeldener, Whitestone, NY (US); David Barron, Scottsdale, AZ (US)

(73) Assignee: CONTINENTAL AUTOMOTIVE SYSTEMS, INC., Deer Park, IL (US)

(21) Appl. No.: 13/085,814

(22) Filed: Apr. 13, 2011

(51) Int. Cl. G10L 15/20

(52) U.S. Cl. 704/233; 704/E15.039

(57) ABSTRACT

An input signal is received. A plurality of electrical characteristics from the input signal is obtained. A plurality of acoustic features is determined from the obtained electrical characteristics and each of the acoustic features being different from the others. At least some of the acoustic features are compared to a plurality of predetermined criteria. Based upon the comparing of the acoustic features to the plurality of predetermined criteria, it is determined when the signal is a voice signal or a noise signal.

### FIELD OF THE INVENTION

The invention relates generally to analyzing electrical signals, and, more specifically to determining whether a signal is a voice signal.

### BACKGROUND OF THE INVENTION

Different types of audio signals are received at and sent from vehicles. For instance, downlink signals are received from some other location. Uplink signals are sent from a vehicle to some other destination. Speakers broadcast the downlink speech signals that are received, and microphones receive the speech of occupants in the vehicle for transmission. As different speech signals are transmitted and received, these signals may be reflected in the vehicle or at other places, and echoes can occur. The presence of echoes degrades the quality of speech for listeners and echo cancellers have been developed to attenuate echoes.

Acoustic echo cancellers are typically used in vehicles as part of hands-free equipment due to the close proximity of loud speakers with open microphones. However, echo cancellers can typically provide only a portion of the cancellation required in vehicular environments because of the high coupling between the loud speakers and the microphones. As a result, echo suppression approaches are used in addition to echo cancellers to increase the attenuation of echoes to an acceptable level.

Voice activity detection (VAD) approaches play an important role in speech signal processing techniques. VAD techniques are used to determine whether a signal is a speech signal or noise. In particular, VAD approaches are used (for example, in vehicles, on the street, or at railway stations) in speech processing techniques such as speech enhancement (i.e., acoustic echo cancellation, noise suppression), speech coding, and automatic speech recognition. Since these techniques depend upon VAD accuracy or sometimes assume ideal VAD, insufficient accuracy seriously affects their practical performance.

In general, VAD typically consists of two parts: an acoustic feature extraction part, and a decision mechanism part. The former extracts acoustic features that can appropriately indicate the probability of target speech signals existing in observed signals, which also include environmental sound signals. Based on these acoustic features, the latter part finally decides whether the target speech signals are present in the observed signals using, for example, a well-adjusted threshold, the likelihood ratio, or hidden Markov models.

The performance of the each part significantly influences VAD performance. Simple threshold based VAD approaches assume the stationary noise within a certain temporal length; consequently, these approaches are sensitive to changes in the signal to noise ratios (SNRs) of observed signals and non-stationary noise. However, in practice, environmental sound is not stationary and its power changes dynamically within a short time. This sensitivity makes it difficult to decide the optimum threshold, which prevents VAD methods from being used in many environments. Therefore, these previous approaches have proved inadequate in determining whether a signal was speech or noise.

### BRIEF DESCRIPTION OF THE DRAWINGS

The present invention is illustrated, by way of example and not limitation, in the accompanying figures, in which like reference numerals indicate similar elements, and in which:

FIG. 1 comprises a block diagram of an apparatus for determining whether a signal is speech or noise according to various embodiments of the present invention;

FIG. 2 comprises a flowchart of an approach for determining whether a signal is speech or noise according to various embodiments of the present invention;

FIG. 3 comprises a flowchart of an approach for determining whether a signal is speech or noise according to various embodiments of the present invention;

FIG. 4 comprises a flowchart for adapting of short term predictor characteristics according to various embodiments of the present invention;

FIG. 5 comprises a flowchart of a smoothing approach according to various embodiments of the present invention;

FIG. 6 comprises a flowchart of a periodicity detection algorithm according to various embodiments of the present invention;

FIG. 7 comprises a flowchart for determining a background noise power update according to various embodiments of the present invention;

FIG. 8 comprises a flowchart for speech signal power adaptation according to various embodiments of the present invention;

FIG. 9 comprises a flowchart for voicing probability smoothing according to various embodiments of the present invention;

FIG. 10 comprises a flowchart for the final VAD decision according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

In the approaches described herein, a VAD algorithm utilizes variety of robust acoustic features that represent the characteristics of observed signals. These approaches are not based on a single threshold mechanism and utilize a combination of acoustic features to determine whether a signal is speech or noise. To mention a few examples, these acoustic features may be the moving average autocorrelation function, a spectral comparison based on spectral distortion measure, a spectral voicing probability estimate, long term speech prediction using cross correlation, the degree of periodicity based on speech pitch deviations, the long term sub-band power estimation, background noise estimate for each sub-band, or a sub-band SNR estimate and voicing probability based on SNR estimates. A VAD is computed using the combined decision for combinations of acoustic features described above. In so doing, the accuracy of the VAD is improved compared to previous approaches. As used herein, “VAD” refers to voice activity detection approaches that determine whether a signal is speech (voice) or noise.

In many of these embodiments, an input signal is received. A plurality of electrical characteristics from the input signal is obtained. A plurality of acoustic features is determined from the obtained electrical characteristics and each of the acoustic features is different from the others. At least some of the acoustic features are compared to a plurality of predetermined criteria. Based upon the comparison of the acoustic features to the plurality of predetermined criteria, it is determined whether the signal is a voice signal or a noise signal.

In some aspects, the electrical characteristics are spectral characteristics, filtered input signals, power characteristics, or voltage characteristics. In other aspects, the acoustic features may be a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, or a voicing probability. Other examples of electrical characteristics and acoustic features are possible.

In other aspects, each of the acoustic features is compared to different predetermined criteria. In still other examples, the signal is received at a vehicle. In yet other examples, a device at the vehicle is operated according to whether the determination is a noise signal or a voice signal, and the device may be an Automatic Gain Control (AGC) device, a noise suppression device, a speech enhancement device, or an Echo cancellation device. Other examples of locations for receiving the signal and devices operated or controlled (at least in part) by the signal are possible.

In others of these embodiments, an apparatus for determining whether a signal is a voice signal or a noise signal includes an interface and a control unit. The interface has an input and an output. The interface is configured to receive an input signal at the input and obtain a plurality of electrical characteristics from the input signal. The control unit is coupled to the interface and is configured to determine a plurality of acoustic features from the obtained electrical characteristics. Each of the acoustic features is different from the others. The control unit is configured to compare at least some of the acoustic features to a plurality of predetermined criteria and, based upon the comparison of the acoustic features, to the plurality of predetermined criteria, determine when the signal is a voice signal or a noise signal, and present the determination at the output.

The electrical characteristics can be a wide variety of electrical characteristics. For example, the electrical characteristics may be spectral characteristics, a filtered input signal, power characteristics, and voltage characteristics. Other examples of electrical characteristics are possible.

In other aspects, each of the plurality of acoustic features is different from the others and may be, for example, a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, or a voicing probability. Other examples of acoustic features are possible.

In still other aspects, the control unit is configured to compare each of the acoustic features to a different criteria of the plurality of predetermined criteria. In yet other aspects, the apparatus is disposed at a vehicle. If in a vehicle, the apparatus may be coupled to a device at the vehicle such as an Automatic Gain Control (AGC) device, a Noise suppression device, a speech enhancement device, or an Echo cancellation device. Other examples of devices can be controlled by the determination.

In others of these embodiments, an input signal is received. A plurality of voltage or power characteristics is obtained from the input signal. Based upon the voltage and power characteristics, at least two acoustic features is determined. For example, these features may be a signal-to-noise ratio, a voicing probability, and a speech spectral voicing and spectral deviation. At least some of the acoustic features are compared to a plurality of predetermined criteria. Based upon the comparing of the acoustic features to the plurality of predetermined criteria, it is determined when the signal is a voice signal or a noise signal. The determination can be used to control other devices as well.

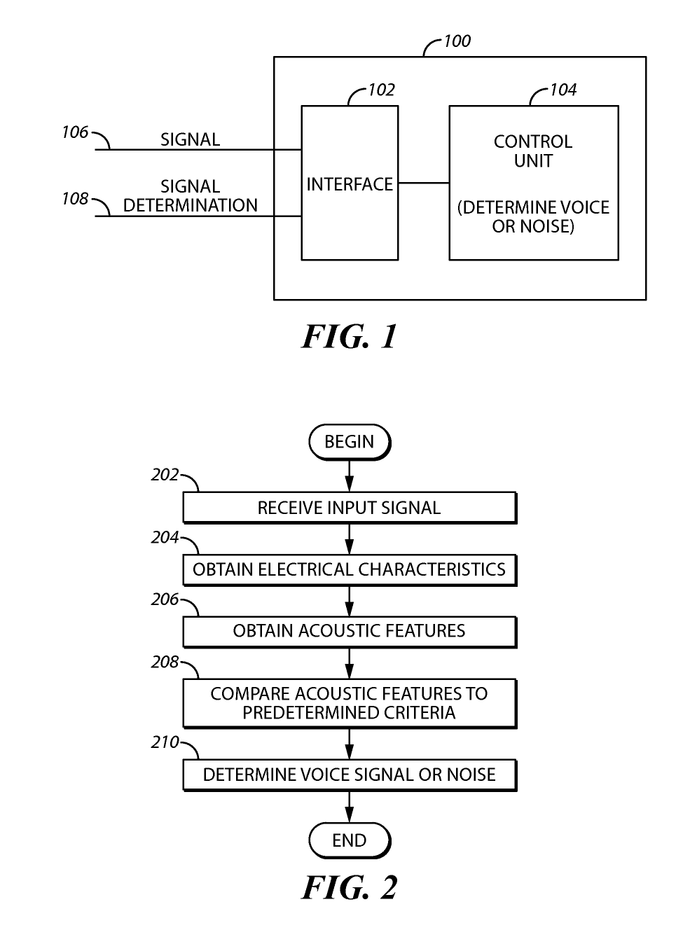

Referring now to FIG. 1, an apparatus 100 for determining whether a signal is a voice signal or a noise signal includes an interface 102 and a control unit 104. The interface 102 has an input 106 and an output 108. The interface 102 is configured to receive an input signal at the input 106 and obtain a plurality of electrical characteristics from the input signal. The control unit 104 is coupled to the interface 102 and is configured to determine a plurality of acoustic features from the obtained electrical characteristics. Each of the acoustic features is different from the others. The control unit 104 is configured to compare at least some of the acoustic features to a plurality of predetermined criteria and, based upon the comparison of the acoustic features to the plurality of predetermined criteria, determine when the signal is a voice signal or a noise signal and present the determination at the output 108.

The electrical characteristics can be a wide variety of electrical characteristics. For example, the electrical characteristics may be spectral characteristics, a filtered input signal, power characteristics, and voltage characteristics. Other examples of electrical characteristics are possible.

In other aspects, each of the plurality of acoustic features is different from the others and may be, for example, a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, or a voicing probability. Other examples of acoustic features are possible.

In other aspects, the control unit 104 is configured to compare each of the acoustic features to different criteria of the plurality of predetermined criteria. In still other aspects, the apparatus 100 is disposed at a vehicle. If in a vehicle, the apparatus may be coupled to a device at the vehicle such as an Automatic Gain Control (AGC) device, a Noise suppression device, a speech enhancement device, and an Echo cancellation device and may be used to operate/control these devices. Other examples of devices are possible.

Referring now to FIG. 2, an approach for determining whether a signal is speech or noise is described. At step 202, an input signal is received. At step 204, a plurality of electrical characteristics from the input signal is obtained. In some aspects, the electrical characteristics are spectral characteristics, filtered input signals, power characteristics, or voltage characteristics. At step 206, a plurality of acoustic features is determined from the obtained electrical characteristics and each of the acoustic features being different from the others. In other aspects, each of the plurality of acoustic features is different from the others and may be, for example, a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, or a voicing probability. Other examples are possible.

At step 208, at least some of the acoustic features are compared to predetermined criteria. At step 210 and based upon the comparison of the acoustic features to the plurality of predetermined criteria, it is determined whether the signal is a voice signal or a noise signal.

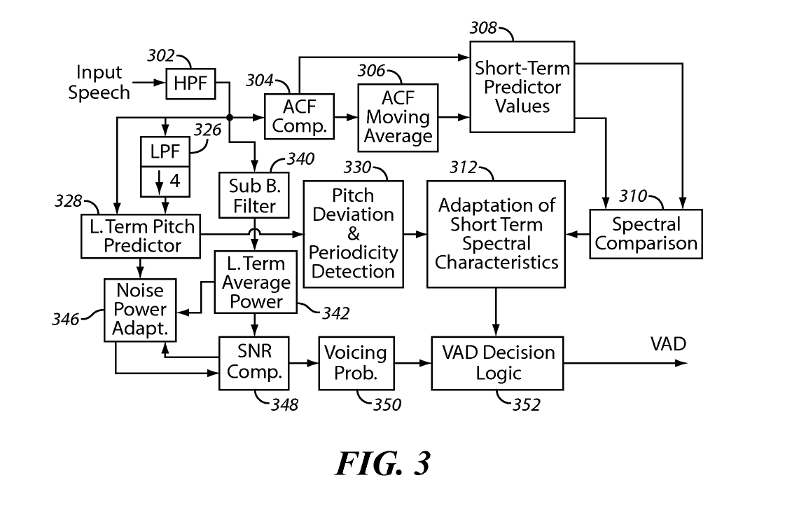

Referring now to FIG. 3, a voice activity detection (VAD) algorithm that can be used in a hands-free system, for example, in a vehicle is described. Among other things, the VAD algorithm and determination is based on the signal to background noise ratio (SNR), voicing probability, and Speech Spectral Voicing and Spectral Deviations (based on short and long term pitch predictors). The VAD algorithm can be used as a control mechanism to control the operation of Automatic Gain Control (AGC) devices, Noise Suppression (NS) devices, Speech Enhancement and Acoustic Echo Cancellation Blocks or devices among other devices or algorithms.

At step 302, the input speech is high passed filtered in order to condition the input signal against excessive low frequency noise that can degrade the voice quality. In one example, the cut-off frequency of the HPF filter is defined as 120 Hz. The transfer function of this filter can be written as:

$$H ( z ) = {\prod }_{k = 1}^{3} {F}_{k} ( z ) \qquad ( 1 )$$

Where Fₖ(z) can be defined as:

$${F}_{k} ( z ) = \frac{{\sum }_{n = 0}^{2} {a}_{k} ( n ) {Z}^{- n}}{1 + {\sum }_{n = 1}^{2} {b}_{k} ( n ) {Z}^{- n}} \qquad ( 2 )$$

It will be appreciated that the various approaches and algorithms described herein can be implemented via computer instructions stored on a computer media and executed by a processing device such as a microprocessor or the like.

At step 304, spectral characteristics based on short term prediction are computed. Short term prediction (all-pole model) may be used since these correspond to autoregressive (AR) process to determine the speech spectral shape or envelope. The all-pole spectrum is related to the AR autocorrelation function by:

$$\begin{matrix}R ( n ) = {\sum }_{ω = 0}^{N - 1} \frac{{σ}^{2}}{\vert {A}_{p} ( ω ) {\vert}^{2}} {e}^{jn ω} & ( 3 ) \\ With {A}_{p} ( ω ) = 1 + {\sum }_{k = 1}^{P} {a}_{k} {e}^{- jkw} & ( 4 )\end{matrix}$$

Where aₖ are the AR or short term predictor parameters for the P^{th} model order and σ is the short term prediction gain. Using short term predictor parameters, the characteristics of the speech spectra can be obtained which can be used in voice activity detection applications. In other words, voice activity detection may be based at least in part upon short term predictor spectral characteristics.

At step 306, spectral characteristics of the input signal are obtained by using the moving average of the Autocorrelation Function (ACF) values for several consecutive frames. The moving average of ACF values, R_{avg}(m,j) for j^{th} component of m^{th} frame is computed as:

$${R}_{avg} ( m , j ) = {\sum }_{k = 0}^{M} R [ ( m - k ) , j ] ; j = 0 , 1 , 2 , ⋯ , P \qquad ( 5 )$$

Where R[(m−k), j] is the ACF for the j^{th} component of (m−k)^{th} speech frame, M is the number of frames that is being averaged and P is the number of taps or order for the Short Term Predictor (STP).

At step 308, estimation of short term predictor coefficients occurs. There are various approaches in order to estimation the short term predictor coefficients. In this particular VAD algorithm, the autocorrelation method is used as formulated in the following:

$$\begin{matrix}φ ( i , j ) = {\sum }_{n = 0}^{N + P - 1} s ( n - i ) s ( n - j ) ; i = 1 , 2 , ⋯ , P ; j = 0 , 1 , ⋯ , P & ( 6 ) \\ φ ( i , j ) = R ( \vert i - j \vert ) ; i = 1 , 2 , ⋯ , P ; j = 0 , 1 , ⋯ , P \\ Where & ( 7 ) \\ R ( j ) = {\sum }_{n = 0}^{N - 1 - j} s ( n ) s ( n + j ) & ( 8 )\end{matrix}$$

In order to estimate short term predictor coefficients for the VAD application, then the autocorrelation function, R(j) is replaced with the moving average autocorrelation coefficients, R_{avg}([m−M], j). The short term predictor coefficients, a(j) can be then obtained by solving the following equations:

$${\sum }_{j = 1}^{P} a ( j ) {R}_{avg} ( [ m - M ] , \vert i - j \vert ) = R ( i ) ; i = 1 , 2 , ⋯ , P \qquad ( 9 )$$

Durbin's method is one possible technique which is based on a recursive solution for the computation of the short term predictor coefficients. Durbin's recursive procedure is given as follows:

$$\begin{matrix}E ( 0 ) = {R}_{avg} ( [ m - M ] , 0 ) & ( 10 ) \\ α ( 0 , 1 ) = 0 & ( 11 ) \\ {k}_{i} = \frac{[ {R}_{avg} ( [ m - M ] , i ) - {\sum }_{j = 1}^{i - 1} α ( i - 1 , j ) {R}_{avg} ( [ m - M ] , i - j ) ]}{E ( i - 1 )} ; 1 ≦ i ≦ P & ( 12 ) \\ α ( i , i ) = {k}_{i} & ( 13 ) \\ α ( i , j ) = α ( i - 1 , j ) - {k}_{i} α ( i - 1 , i - j ) ; 1 ≦ j ≦ i - 1 & ( 14 ) \\ E ( i ) = ( 1 - {k}_{i}^{2} ) E ( i - 1 ) & ( 15 )\end{matrix}$$

Through solving Equations (10) to (15) recursively for 1≦i≦P, the short term predictor coefficients, a(j) is obtained by:

a(j)=α(P,j); j=1,2, . . . ,P (16)

After obtaining the short term predictor coefficients, then the auto-correlation function for the short term predictor coefficients is computed as

$${R}_{STP} ( i ) = {\sum }_{k = 0}^{P - i} a ( k ) a ( k + i ) ; i = 0 , 1 , ⋯ , P \qquad ( 17 )$$

Finally, the short term predictor gain, β_{STP} is calculated as in the following equation:

$${β}_{STP} = {R}_{N} ( 0 ) R ( 0 ) + 2 {\sum }_{i = 1}^{P} {R}_{N} ( i ) R ( i ) \qquad ( 18 )$$

Where R_{N} (i) are updated auto-correlated short term predictor coefficients for noise based on the R_{STP} (i) values computed using the short term spectral characteristics (R_{N}(i)=R_{STP} (i) during the adaptation time instances). This corresponds to performing an P^{th} order short term prediction using block filtering of the input speech signal.

At step 310, a spectral comparison based on spectral distortion measures is performed. The spectra represented by the auto-correlated short term predictor coefficients and the averaged autocorrelation values of input speech signal are compared using the normalized spectral distortion measure, S_{dm} (m) as defined below. This measure is used to identify the noise or speech signals and computed as given in the following equation:

$${S}_{dm} ( m ) = \frac{{R}_{STP} ( 0 ) {R}_{avg} ( m , 0 ) + 2 {\sum }_{i = 1}^{P} {R}_{STP} ( i ) {R}_{avg} ( m , i )}{{R}_{avg} ( m , 0 )} \qquad ( 19 )$$

The spectral deviation factor from one frame to the next is then computed as:

Δ_{S}=|S_{dm}(m)−S_{dm}(m−1) (20)

The spectral deviation factor is compared against a predefined spectral distance threshold, SD_{THR} and based on this comparison, the spectral shape of speech is declared as either stationary or non-stationary as given in the following equation:

$$Spectral\_Stationary \_Flag = \{ \begin{matrix}1 & ; {Δ}_{s} < {SD}_{THR} \\ 0 & ; Otherwise\end{matrix} \qquad ( 21 )$$

The background noise estimate, the adaptive short term prediction gain factor and auto-correlated short term predictor coefficients of noise, {R_{N}(j)} where 0≦j≦P are updated when the spectra of the input signal is stationary as will be described later in this document.

At step 312, the adaptation of short term predictor characteristics occurs. The adaptation factors (the adaptive short term prediction gain factor, β_{ADAP} and the auto-correlated short term predictor coefficients for noise, R_{N}(i) are adapted if there is a low probability that speech or information tones are present. This adaptation takes place when the following conditions are met. First, If the spectral shape of the input signal is stationary (Spectral_Stationary_Flag=1). Second, If the degree of periodicity is very low and as a result the speech is a non-periodic signal (Periodicity_Flag=0). Third, if the Long Term Prediction Gain, β_{LTP} is very low (below a predetermined threshold).

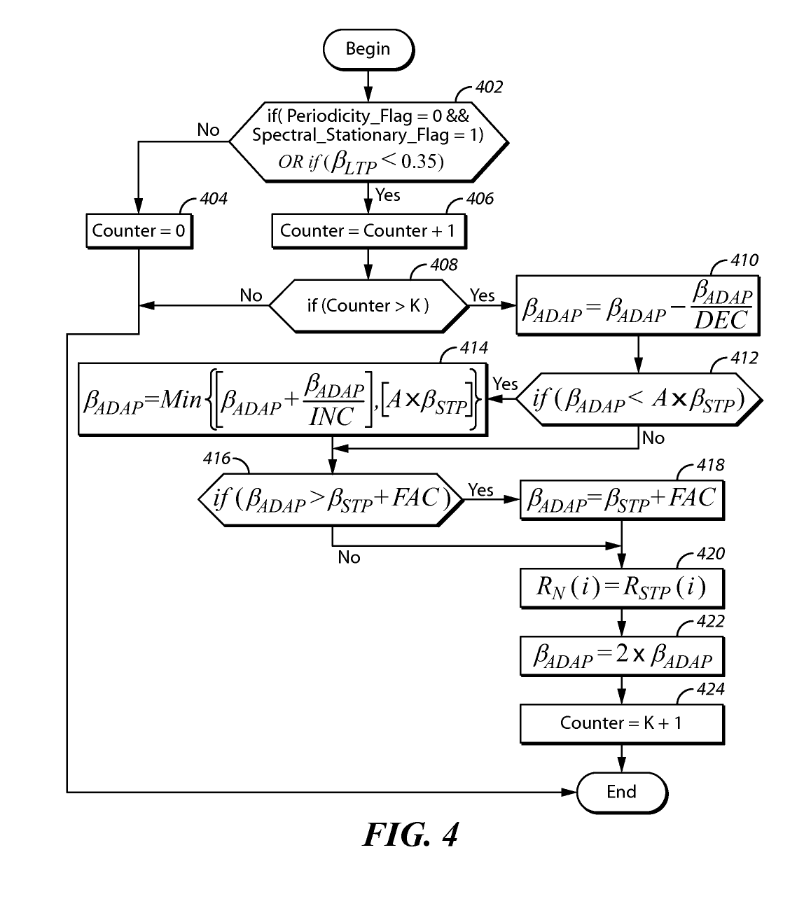

This algorithm is described in greater detail with respect to FIG. 4 below.

The spectral voicing factor, P_{S}(m) based on the short term spectral and long term pitch delay characteristics for the m^{th} speech frame is computed as:

$${P}_{S} ( m ) = \frac{{β}_{STP}}{{β}_{ADAP}} \qquad ( 22 )$$

Where β_{STP} is the short term predictor gain for the current frame computed as in equation 18 and β_{ADAP} is the long term adaptive gain factor for the short term predictor estimated as shown in FIG. 4.

One of the most prevalent features in speech signals is the periodicity of voiced speech known as pitch. Pitch has many applications in speech signal processing, such as phonetics, linguistics, speaker identification, speech coding and voice activity determination (VAD) of noisy speech signals, and so forth. As described herein, the pitch for VAD applications can be considered in making the determination of whether a signal is a speech signal or a noise signal.

At step 326, low pass filtering and decimation occurs. More specifically, prior to estimate of the pitch and degree of voicing of speech signals, the input speech is low passed filtered at B kHz (e.g., B=1 kHz). The low pass filtered speech is then decimated by a factor of D (e.g., D=4). One reason for low pass filtering and decimation is to reduce the computational complexity significantly during the search for long term pitch and gain predictions. Low pass filtering also eliminates high frequency noise that enables more reliable pitch determination and hence a more reliable voicing measure.

At step 328, long term predictions using cross correlation are made. The pitch of speech is the time delay that maximizes the cross correlation function of the input speech signal. Since speech is a non-stationary signal, the normalized cross correlation function was found to be very suitable for long term pitch prediction of speech applications. The normalized cross correlation function can therefore be formulated as:

$$C ( t ) = \frac{{\sum }_{n = 0}^{N} s ( n ) s ( n + t )}{\sqrt{{\sum }_{n = 0}^{N} {s ( n )}^{2}} \sqrt{{\sum }_{n = 0}^{N} {s ( n + t )}^{2}}} ; {T}_{min} ≦ t ≦ {T}_{max} \qquad ( 23 )$$

Where s(n) and t are the input speech signal and a pitch candidate respectively. Tₘᵢₙ and Tₘₐₓ are the minimum (20) and maximum (120) pitch values. In order to reduce the computational complexity prior computing the normalized cross correlation, then the input speech signal, s(n) is low pass filtered and then decimated by a factor of D (e.g., D=4) as described previously. The normalized cross correlation function applied to the decimated signal can be formulated as:

$$\hat{C} ( {t}^{′} ) = \frac{{\sum }_{k = 0}^{N \text{/} D} {s}_{l} ( k ) {s}_{l} ( k + {t}^{′} )}{\sqrt{{\sum }_{k = 0}^{N \text{/} D} {{s}_{l} ( k )}^{2}} \sqrt{{\sum }_{k = 0}^{N \text{/} D} {{s}_{l} ( k + {t}^{′} )}^{2}}} ; \frac{{T}_{min}}{D} ≦ {t}^{′} ≦ \frac{{T}_{max}}{D} \qquad ( 24 )$$

Where sₗ(k) and t′ are the decimated low pass filtered speech, and a decimated pitch candidate respectively. The decimated optimal pitch, T_{d}, corresponding to the maximum positive normalized cross correlation value, β_{d} defined as long term prediction gain, is searched and found as:

$$\begin{matrix}{β}_{d} = Max [ \hat{C} ( {t}^{′} ) ] ; \frac{{T}_{min}}{D} ≦ {t}^{′} ≦ \frac{{T}_{max}}{D} & ( 25 ) \\ {β}_{d} = \hat{C} ( {T}_{d} ) & ( 26 )\end{matrix}$$

The most optimal pitch, T₀ and long term prediction gain, β_{LTP} for 8 kHz input signal are computed around the initially estimated pitch period, T_{d} by using the non-decimated signal as given in the following equations:

β_{LTP}=Max[C(t)]; (D×T_{d}3)≦t≦(D×T_{d}+3)

β_{LTP}=C(T₀) (27)

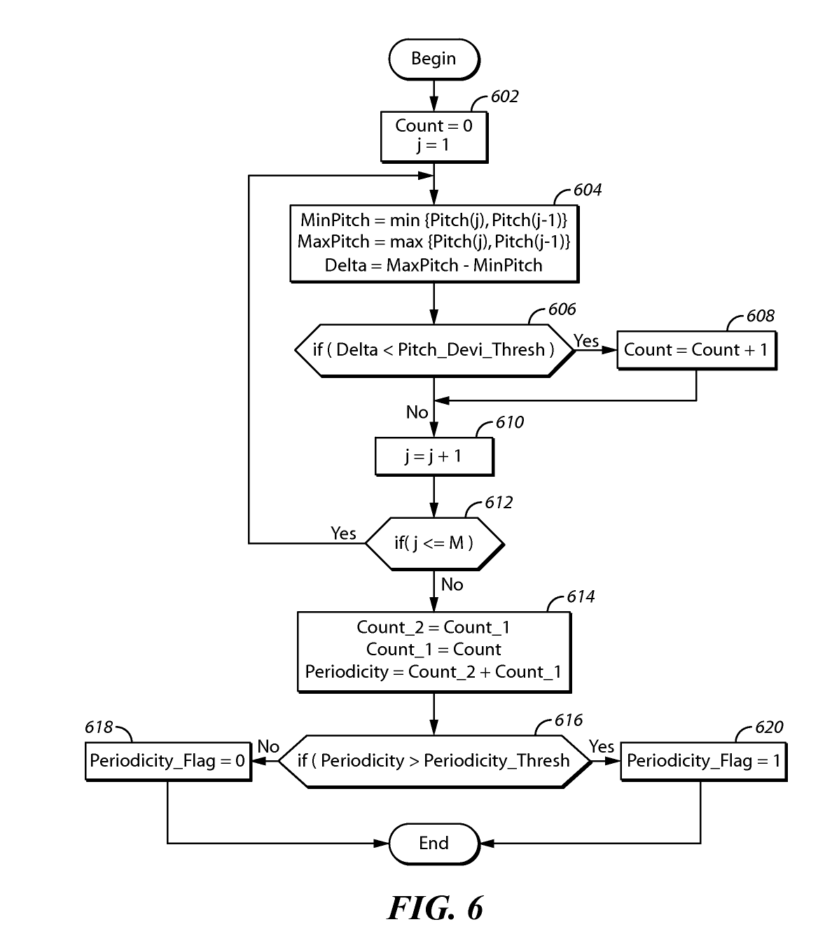

At step 330, periodicity detection based on pitch deviations is performed. As mentioned above, the background noise estimate, the long term adaptive gain factor for short term predictor and auto-correlated short term predictor coefficients, {R_{N}(j)=R_{STP}(j)} where 0≦j≦P are updated when the spectral shape of the input signal is stationary. Vowel sounds of speech signals also have stationary spectral characteristics. Therefore, periodicity detection is also used to indicate the presence of a periodic signal component and prevents adaptation of the background noise estimate, the long term adaptive gain factor for short term predictor and auto-correlated predictor coefficients. The periodicity detector identifies the vowel sounds by comparing consecutive Long Term Predictor (LTP) pitch values which are obtained during the normalized cross correlation pitch search as described in previous sections. In this case, a good pitch counter is computed based on the distance between the neighbouring pitch values. One approach for the periodicity detection algorithm based on the computation of pitch deviation values is shown in FIG. 6.

SNR based voicing probability characteristics are determined. More specifically, the VAD is computed based on the SNR estimation of variety of sub-band signals while using the spectral as well as periodicity characteristics of speech described in previous sections.

At step 340, Sub-Band Power Computation occurs. The voicing probability determination algorithm is based on the estimated SNR computations to determine the voicing probability for the current frame. Therefore, the input high pass filtered speech is divided into two sub-bands; the first sub-band spans (for example) the 0-2 kHz band and the second sub band spans (for example) the 2-4 kHz band. The k^{th} sub-band power is computed as follows:

$$\begin{matrix}P ( k ) = R ( 0 ) {R}_{k} ( 0 ) + 2 {\sum }_{n = 1}^{N} R ( n ) {R}_{k} ( n ) \\ Where \text{:} & ( 28 ) \\ {R}_{k} ( n ) = {\sum }_{j = 0}^{N - j} {h}_{k} ( j ) {h}_{k} ( j + n ) ; 0 ≦ n ≦ N & ( 29 )\end{matrix}$$

Where hₖ (j) is the impulse response of the k^{th} sub-band filter, where 1≦k≦2. and R(n) is the autocorrelation function of input speech. At step 342, Long Term Average Sub-Band Power Computation occurs. The sub-band power, P(k) computed in Equation 28 is long-term averaged and used to estimate both the background noise power and signal power. The long-term power is computed as:

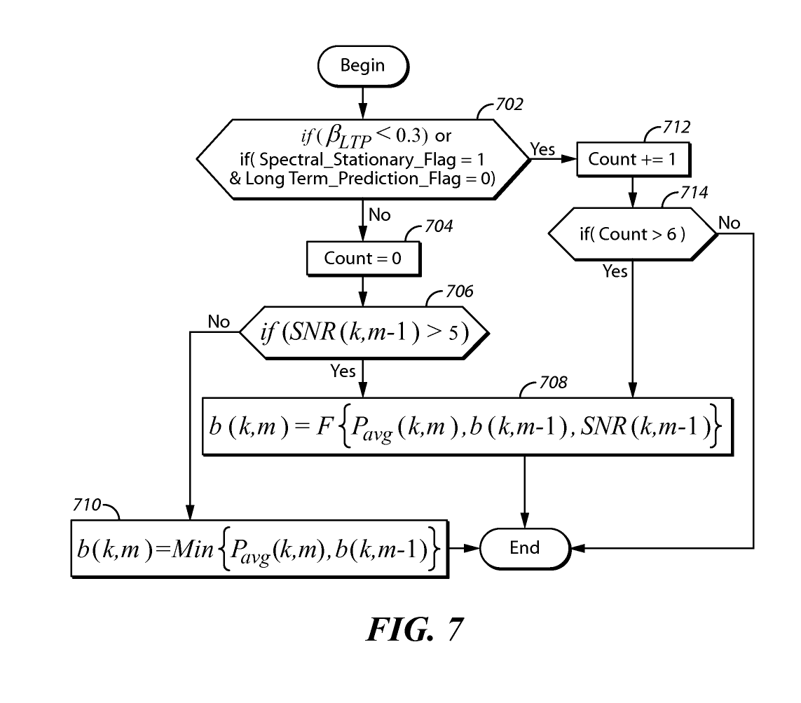

P_{avg}(k,m)=αP_{avg}(k,m−1)+(1−α)P(k); 1≦k≦2 (30)

Where m corresponds to current speech frame and typically α=0.7. An estimate of the background noise power for the k^{th} sub-band, b(k,m), is computed for the current, or m^{th} frame using b(k,m−1), P_{avg}(k,m) and SNR. The flowchart of the background noise power update for k^{th} sub-band is shown in FIG. 7.

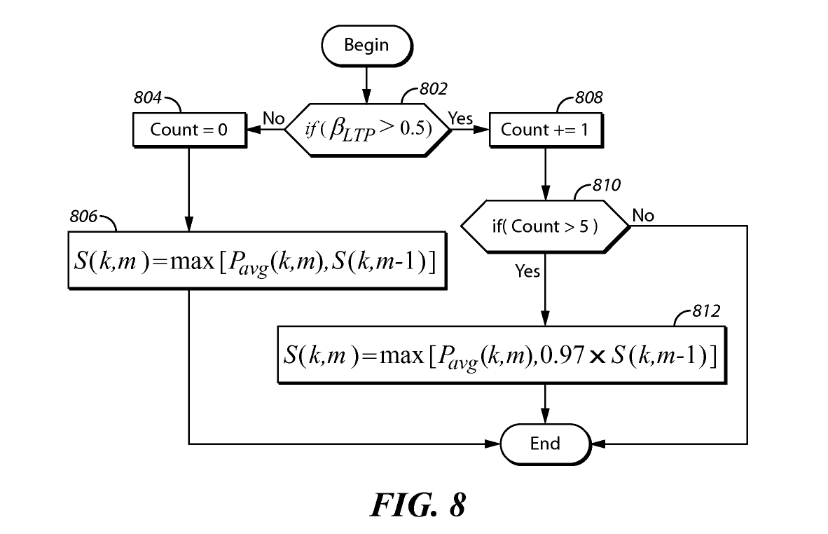

At step 346, speech signal power adaptation occurs. This is explained in greater detail with respect to FIG. 8.

A Signal To Ratio (SNR) Computation is made. The signal to noise ratio (SNR) for the k^{th} sub-band and m^{th} frame is then computed as follows:

$$SNR ( k , m ) = 10 {log}_{10} [ \frac{S ( k , m )}{b ( k , m )} ] \qquad ( 31 )$$

At step 350, a Voicing Probability Estimation is made. The voicing probability is determined by comparing the signal to background noise ratio (SNR) in two frequency sub-bands. The voicing probability for the k^{th} sub-band and m^{th} frame can be estimated as follows:

Pᵥ(k,m)=Q[SNR(k,m)] (32)

Where Q[x] is the quantization or mapping operand for SNR that quantizes or maps the SNR's into a voicing probability value for each sub-band that takes value in between 0 and 1, where 1 corresponds to the signal with very high probability being speech signal; and 0 corresponds to the signal with very high probability being background noise signal. Quantization or mapping thresholds are determined by an estimated signal-to-noise ratio in each sub-band. The highest voicing probability calculated from the two sub-bands is then selected as the voicing probability of current frame as given in the following equation:

Pᵥ(m)=Max{Pᵥ(1,m),Pᵥ(2,m)} (33)

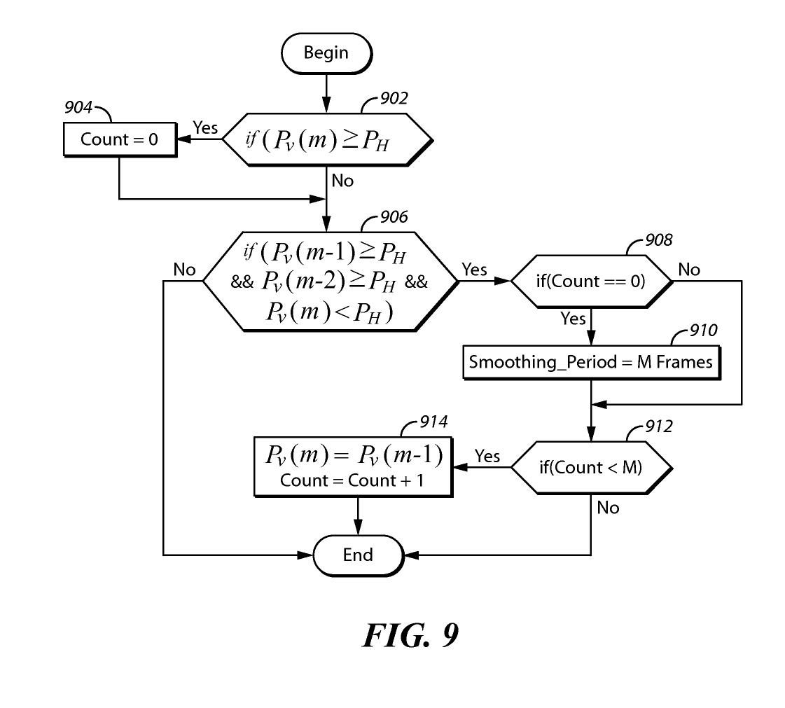

A Voicing Probability Smoothing Algorithm can also be used. If the voicing probability computation transitions from at least two consecutive high voicing probability frames to a lower voicing probability frame, then the next M frames are treated as high voicing before allowing the voicing probability to drop to Medium and finally to Low voicing. The number of smoothing frames, M, is a function of the estimated SNR computation. The smoothing algorithm is defined in the flowchart as shown in FIG. 9. In FIG. 9, Pᵥ(m) is the voicing probability of the current frame and Pᵥ(m−1) & Pᵥ(m−2) are the voicing probabilities of the previous two frames, respectively, and P_{H} is the high voicing probability threshold.

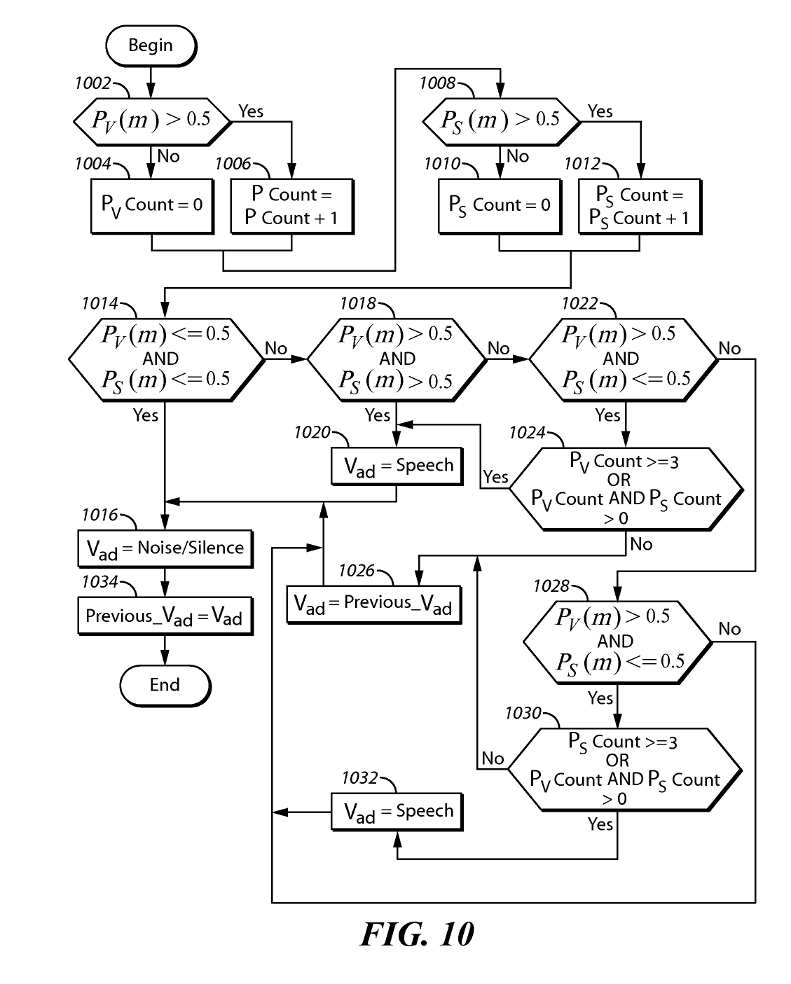

At step 352, the VAD decision algorithm is made for the final decision of whether the signal is a voice signal or a noise signal. This is described in greater detail with respect to FIG. 10.

Referring now to FIG. 4, one example of an approach for adapting short term predictor characteristics is described. In this flow approach, the Periodicity_Flag and β_{LTP} represents the periodic/aperiodic states of speech, and long term prediction gain respectively. The definitions, K, INC, DEC and FAC are predefined constants for this adaptation scheme.

At step 402, it is determined if the periodicity_flag=0 and spectral_stationary_flag=1 or if β_{LTP} is less than 0.035. If the answer is negative, the counter is set to zero and execution ends. If the answer is affirmative, at step 406 the counter is incremented by 1. At step 408, it is determined if the counter is greater than k. If the answer is negative, execution ends. If the answer is affirmative, at step 410, β_{ADAP} is set to be β_{ADAP}−β_{ADAP}/DEC. At step 412, it is determined if β_{ADAP} is less that β_{ADAP}*A. If the answer is affirmative, then execution continues at step 414. If the answer is negative, execution continues at step 416.

At step 414, β_{ADAP} is set to be Min{[β_{ADAP}+β_{ADAP}//INC], {A*β_{ADAP}]}.

At step 416, it is determined if β_{ADAP} is greater than β_{STP}+FAC. If the answer is affirmative, execution continues at step 418. If the answer is negative, then execution continues at step 420.

At step 418, β_{ADAP} is set to β_{STP}+FAC. At step 420, RN(i) is set to RSTP(i). Next at step 422 β_{ADAP} is set to 2*β_{ADAP}. At step 424, the counter is incremented. Execution then ends.

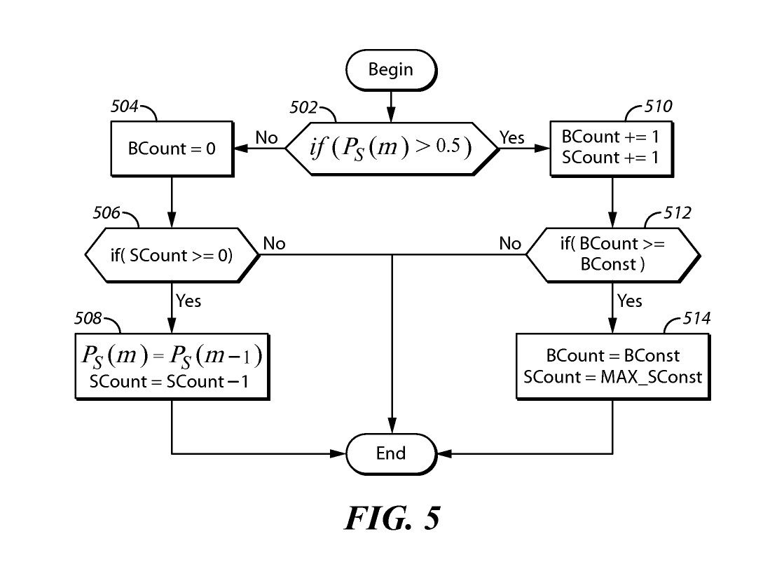

Referring now to FIG. 5, one approach to smoothing is described. The smoothing feature is only added to bursts of high spectral voicing greater than or equal to a predefined threshold. In this example, BCount represents the number of consecutive frames that Ps(m) is greater than a predefined threshold, SCount represents the number of frames to hold Ps(m) constant (hang time), BConst represents the number of consecutive frames of Ps(m) greater than the predefined threshold at which to declare a maximum hold time for Ps(m), and MAX_SConst represents the maximum hold time for Ps(m).

At step 502, it is determined if Ps(m)>0.5. If the answer is negative, execution continues at step 504. If the answer is negative, execution continues at step 504. If the answer is affirmative, execution continues at step 510.

At step 504, BCount is set to 0 At step 506, it is determined if SCount>=0. If the answer is negative, execution ends. If the answer is affirmative, execution continues at step 508. At step 508, Ps (m)=Ps (m−1) and SCount is set equal to SCount−1.

At step 510, BCount is incremented by 1 and SCount is incremented by 1. At step 512, it is determined if BCount>=BConst. If the answer is negative, execution ends. If the answer is affirmative, execution continues at step 514. At step 514, BCount is set equal to BConst and SCount is set equal to MAX_SConst.

Referring now to FIG. 6 (F/C FIG. 4) a flowchart for the periodicity detection algorithm based on the computation of pitch deviation values is described. In this example, MinPitch represents the shorter pitch period of the current frame and the previous frame; MaxPitch represents longer pitch period of the current frame and the previous frame; Delta represents the change in the pitch period from the previous frame to the current frame, Pitch_Devi_Thresh is the threshold at which larger changes in pitch periods are declared invalid; Count, Count_1, and Count_2 are the number of valid pitch periods over the last M frames and previous M frames, Periodicity represents the total number of valid frames over the last M+1 frames; and Periodicity flag represents the presence of valid pitch.

At step 602, Count is set to 0 and j is set to 1. At step 604, MinPitch is set to be min{Pitch(j), Pitch(j−10}. Then, MaxPitch is set to max{Pitch(j), Pitch(j−1)}. Then, Delta is set to MaxPitch−MinPitch.

At step 606, it is determined if Delta<Pitch_Devi_Thresh. If the answer is affirmative, execution continues at step 608. If the answer is negative, execution continues at step 610. At step 608, Count=Count+1, execution continues at step 610.

At step 610, j=j+1. At step 612, it is determined if j<=M. If the answer is affirmative, execution continues at step 604. If the answer is negative, execution continues at step 614. At step 614, Count 2 is set to Count 1. Then, Count_1 is set to Count. Then, Periodicity is set to Count_2+Count_1.

At step 616, it is determined if Periodicity>Periodicity_Thresh. If the answer is negative, execution continues at step 618 where Periodicity_Flag is set to 0. If the answer is affirmative, execution continues at step 620 where Periodicity_Flag is set to 1. Based on the good pitch counter values for the current and previous speech frames, then the periodicity flag is updated accordingly for each speech frame.

Referring now to FIG. 7, one example of a background noise power update for the kth subband is described. In particular, an estimate of the background noise power for the k^{th} sub-band, b(k,m), is computed for the current, or m^{th} frame using b(k,m−1), P_{avg}(k,m) and the signal-to-noise ratio (SNR). The flowchart of the background noise power update for k^{th} sub-band is shown in FIG. 7. β_{LTP}, P_{avg}(k,m), and SNR(k,m−1) are long term prediction gain computed using normalized cross correlation, long term average power and SNR respectively for k^{th} sub-band and m^{th} frame; and F{.} denotes the function operand.

At step 702, it is determined if β_{LTP}<0.3 or if the Spectral_Stationary_Flag is equal to 1 and the Long Term_Prediction_Flag is 0. If the answer is negative, execution continues at step 704 and if the answer is negative, execution continues at step 712.

At step 704, Count is set to 0. At step 706, it is determined if SNR(k,m−1)>5. If the answer is negative, execution continues at step 710. If the answer is affirmative, execution continues at step 708.

At step 710, b(k,m) is set to Min{P_{avg}(k,m), b(k,m−1)}. At step 708, b(k, m) is set to F{P_{avg}(k,m),b(k,m−1), SNR(k,m−1)}

At step 712, Count is incremented by 1. At step 714, it is determined if Count>6. If the answer is affirmative, execution continues at step 708 as described above and if the answer is negative then execution ends.

Referring now to FIG. 8, one example of a speech signal power adaptation approach is described. In this approach, the speech signal power, S(k,m), is adapted.

At step 802, it is determined if β_{LTP}>0.5. If the answer is affirmative, execution continues at step 804. If the answer is negative, execution continues at step 808.

At step 804, count is set to 0. At step 806, S(k,m) is set to max[P_{avg}(k,m),S(k,m−1)].

At step 808, Count is incremented by 1. At step 810, it is determined if Count>5. If the answer is affirmative execution continues at step 812 and if the answer is negative, execution ends. At step 812, S(k,m) is set to be max [P_{avg}(k,m),S(k,m−1)].

Referring now to FIG. 9, one example of a voicing probability smoothing approach is described. Pᵥ(m) is the voicing probability of the current frame and Pᵥ(m−1) & Pᵥ(m−2) are the voicing probabilities of the previous two frames, respectively, and P_{H} is the high voicing probability threshold.

At step 902, it is determined if Pᵥ(m)≧P_{H}. If the answer is negative execution continues at step 906 and if the answer Is affirmative then execution continues at step 904. At step 904, Count is set to 0 and then execution continues at step 906.

At step 906, it is determined if (Pᵥ(m)≧P_{H}) and if (Pᵥ(m−2)>P_{H}) and if Pᵥ(m)<P_{H}. If the answer is negative, execution ends and if the answer is affirmative execution continues at step 908. At step 908, it is determined if Count=0. If the answer is negative, execution continues at step 912 and if the answer is affirmative execution continues at step 910. At step 910, Smoothing_Period is set to M Frames. At step 912, it is determined if Count<M. if the answer is negative, execution ends and if the answer is affirmative at step 914 Pᵥ(m) is set to Pᵥ(m)−1 and Count is incremented by 1.

Referring now to FIG. 10, one example of a final VAD decision algorithm is described. In this example, the final decision as to whether the signal is a voice signal or noise is obtained by using the Voicing Probability, Pᵥ(m) and Spectral Voicing, P_{S}(m) values.

At step 1002, it is determined if Pv(m)>0.5. If the answer is negative, execution continues at step 1004. If the answer is affirmative, execution continues at step 1006. At step 1004, PVcount is set to 0. At step 1006, PCount is incremented by 1. At step 1008, it is determined if Ps(m)>0.5. If the answer is negative, execution continues at step 1010. If the answer is affirmative, execution continues at step 1012.

At step 1010, PScount is set to 0. At step 1012, PScount is incremented by 1. At step 1014, it is determined if (Pv(m)<=0.5 and Ps(m)<=0.5). If the answer is affirmative, execution continues at step 1016. If the answer is negative, execution continues at step 1018.

At step 1016, Vad is set to be Noise/Silence (representing that the signal is silence or noise and not a voice signal). Execution then continues at step 1034. At step 1018, it is determined if Pv(m)>0.5 and Ps(m)>0.5. If the answer is affirmative, execution continues at step 1020. If the answer is negative, execution continues at step 1022.

At step 1020, Vad=Speech (representing the signal is a speech signal and not silence or noise). Execution then continues at step 1034. At step 1022, it is determined if Pv(m)>0.5 and Ps(m)<=0.5. If the answer is affirmative, execution continues at step 1024. If the answer is negative, execution continues at step 1028.

At step 1024, it is determined if PVcount>=3 or PVcount and PScount>0. If the answer is affirmative, execution continues at step 1020. If the answer is negative, execution continues at step 1026 where Vad=Previous_Vad. Execution then continues at step 1034.

At step 1028, it is determined if Pv(m)>0.5 and PS(m)<=0.5. If the answer is affirmative, at step 1030 it is determined if PScount>=3 or PVcount and PScount>0. If the answer at step 1030 is negative, execution continues at step 1026 as described above. If the answer is affirmative, at step 1032, Vad=Speech. At step 1034, Previous_Vad=Vad.

It will be appreciated that many of the approaches described herein utilize variables or constants with particular numeric values or ranges of values. However, it will be understood that these values can be modified to suit the needs of a user or particular application. It will also be understood that the numeric values herein are approximate values and can vary based upon the particular application.

It is understood that the implementation of other variations and modifications of the present invention and its various aspects will be apparent to those of ordinary skill in the art and that the present invention is not limited by the specific embodiments described. It is therefore contemplated to cover by the present invention any modifications, variations or equivalents that fall within the spirit and scope of the basic underlying principles disclosed and claimed herein.

What is claimed is:

1. A method of determining whether a signal is a voice signal or a noise signal, the method comprising:
receiving an input signal;
obtaining a plurality of electrical characteristics from the input signal;
determining a plurality of acoustic features from the obtained electrical characteristics, each of the acoustic features being different from the others;
comparing at least some of the acoustic features to a plurality of predetermined criteria; and
based upon the comparing of the acoustic features to the plurality of predetermined criteria, determining when the signal is a voice signal or a noise signal.

2. The method of claim 1 wherein the electrical characteristics are selected from the group consisting of: a spectral characteristic, a filtered input signal, a power characteristic, a voltage characteristic.

3. The method of claim 1 wherein each of the plurality of acoustic features is different from the others and are selected from the group consisting of: a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, and a voicing probability.

4. The method of claim 1 wherein the determining comprises comparing each of the acoustic features to a different criteria of the plurality of predetermined criteria.

5. The method of claim 1 wherein receiving the signal comprises receiving the signal at a vehicle.

6. The method of claim 5 further comprising operating a device at the vehicle according to whether the determination is a noise signal or a voice signal, the device selected from the group consisting of an Automatic Gain Control (AGC) device, a noise suppression device, a speech enhancement device, and a Echo cancellation device.

7. An apparatus for determining whether a signal is a voice signal or a noise signal, the method comprising:
an interface having an input and an output, the interface being configured to receive an input signal at the input and obtain a plurality of electrical characteristics from the input signal; and
a control unit coupled to the interface, the control unit configured to determine a plurality of acoustic features from the obtained electrical characteristics, each of the acoustic features being different from the others, the control unit configured to compare at least some of the acoustic features to a plurality of predetermined criteria and, based upon the comparison of the acoustic features to the plurality of predetermined criteria, determine when the signal is a voice signal or a noise signal and present the determination at the output.

8. The apparatus of claim 7 wherein the electrical characteristics are selected from the group consisting of: a spectral characteristic, a filtered input signal, a power characteristic, a voltage characteristic.

9. The apparatus of claim 7 wherein each of the plurality of acoustic features is different from the others and are selected from the group consisting of: a moving autocorrelation function, a spectral comparison, a spectral voicing probability estimate, a long term speech prediction based upon a cross correlation, a degree of periodicity based upon speech pitch deviations, a long term sub-band power estimations, a background estimate for each of a plurality of frequency sub-bands, a sub-band signal-to-noise ratio (SNR) estimate, and a voicing probability.

10. The apparatus of claim 7 wherein the control unit is configured to compare each of the acoustic features to a different criteria of the plurality of predetermined criteria.

11. The apparatus of claim 7 wherein the apparatus is disposed at a vehicle.

12. The apparatus of claim 11 wherein the apparatus is coupled to a device at the vehicle, the device being selected from the group consisting of an Automatic Gain Control (AGC) device, a Noise suppression device, a speech enhancement device, and a Echo cancellation device.

13. A method of determining whether a signal is a voice signal or a noise signal, the method comprising:
receiving an input signal;
obtaining a plurality of voltage or power characteristics from the input signal;
based upon the voltage and power characteristics, determining at least two acoustic features selected from the group consisting of a signal-to-noise ratio, a voicing probability, and a speech spectral voicing and spectral deviation;
comparing at least some of the acoustic features to a plurality of predetermined criteria; and
based upon the comparing of the acoustic features to the plurality of predetermined criteria, determining when the signal is a voice signal or a noise signal.

14. The method of claim 13 wherein receiving the signal comprises receiving the signal at a vehicle.

15. The method of claim 14 further comprising operating a device at the vehicle according to whether the determination is a noise signal or a voice signal, the device selected from the group consisting of an Automatic Gain Control (AGC) device, a Noise suppression device, a speech enhancement device, and a Echo cancellation device.
